(19) United States
(12) Patent Application Publication
(10) Pub. No.: US 2026/0290079 A1
(43) Pub. Date: Sep. 24, 2026

(54) GESTURE DETECTION DEVICE, OCCUPANT MONITORING SYSTEM, AND GESTURE DETECTION METHOD

(71) Applicant: Mitsubishi Electric Mobility Corporation, Tokyo (JP)

(72) Inventor: Daiki HIGUCHI, Tokyo (JP)

(73) Assignee: Mitsubishi Electric Mobility Corporation, Tokyo (JP)

(21) Appl. No.: 19/477,997

(22) PCT Filed: Jun. 16, 2023
(86) PCT No.: PCT/JP2023/022338

§ 371 Date: Oct. 23, 2025

(51) Int. Cl. G06V 40/20; B60K 35/10; G06T 7/246; G06T 7/50; G06T 7/73; G06V 40/16

(52) U.S. Cl. CPC G06V 40/28; B60K 35/10; G06T 7/251; G06T 7/50; G06T 7/75; G06V 40/16; B60K 2360/146; G06T 2207/30201; G06T 2207/30268

(57) ABSTRACT

A gesture detection device includes: a hand candidate detection unit to detect a hand candidate that is a candidate of a hand of a person on the basis of a captured image obtained by capturing the person; a gesture detection unit to detect a gesture of the person on the basis of the detected hand candidate; a mask determination unit to determine whether or not the person is wearing a mask on the basis of the captured image; a cover detection unit to determine whether or not a mouth of the person is covered on the basis of face information of the person obtained on the basis of the captured image when the mask determination unit has determined that the person is not wearing a mask; and a determination unit to reject the detected gesture when the cover detection unit has determined that the mouth of the person is covered.

### TECHNICAL FIELD

The present disclosure relates to a gesture detection device, an occupant monitoring system, and a gesture detection method.

### BACKGROUND ART

Conventionally, there is a known technique for detecting a gesture of a person from an image obtained by capturing the person by an imaging device such as a camera. For example, Patent Literature 1 describes an information processing system including an authentication means that executes biometric authentication using biometric information of a first user, an acquisition means that acquires information regarding an action history of the first user in a case where the biometric authentication succeeds, an accumulation means that accumulates the information regarding the action history, a generation means that generates risk information indicating a risk regarding the first user on the basis of the accumulated information regarding the action history, and an output means that outputs the risk information of the first user in response to a request of a second user different from the first user, the information processing system being configured in such a manner that the authentication means (biometric authentication unit) particularly includes a motion information acquiring unit, and the motion information acquiring unit is able to detect a gesture around a cover (for example, a mask or the like) partially covering the face of the first user when executing the biometric authentication of the first user, and acquire motion information corresponding to the gesture. Further, Patent Literature 1 also discloses that the motion information acquiring unit includes, for example, a camera, and may detect a motion of bringing a finger to a position overlapping with the mask as a gesture.

### Citation List

### Patent Literature

Patent Literature 1: WO 2022/264206 A

### SUMMARY OF INVENTION

### Technical Problem

As described above, Patent Literature 1 describes gesture detection when a face of a person (first user) is covered with a mask, that is, when a person is wearing a mask, but does not describe gesture detection when a person is not wearing a mask. On the other hand, in a case where a person eats and drinks, the person makes a motion to bring the hand holding the food or drink to the mouth with the mask removed. At this time, since the motion of a person to bring the hand to the mouth is not intended as a gesture, it is fundamentally undesirable that the motion is detected as a gesture. However, since Patent Literature 1 does not describe gesture detection when a person is not wearing a mask as described above, the system described in Patent Literature 1 has a possibility of erroneously detecting a motion performed by a person when eating or drinking as a gesture.

The present disclosure has been made to solve the above problems, and an object thereof is to obtain a gesture detection device capable of suppressing erroneous detection of a motion performed by a person when eating or drinking as a gesture.

### Solution to Problem

A gesture detection device according to the present disclosure includes: a hand candidate detection unit to detect a hand candidate that is a candidate of a hand of a person on the basis of a captured image obtained by capturing the person; a gesture detection unit to detect a gesture of the person on the basis of the hand candidate detected by the hand candidate detection unit; a mask determination unit to determine whether or not the person is wearing a mask on the basis of the captured image; a cover detection unit to determine whether or not a mouth of the person is covered on the basis of face information of the person obtained on the basis of the captured image when the mask determination unit has determined that the person is not wearing a mask; and a determination unit to reject the gesture detected by the gesture detection unit when the cover detection unit has determined that the mouth of the person is covered.

### Advantageous Effects of Invention

According to the present disclosure, it is possible to suppress erroneous detection of a motion performed by a person when eating or drinking as a gesture.

### BRIEF DESCRIPTION OF DRAWINGS

FIG. 1 is a diagram illustrating a configuration example of an occupant monitoring system including a gesture detection device according to a first embodiment.

FIG. 2 is a flowchart for describing an operation example of the gesture detection device according to the first embodiment.

FIGS. 3A and 3B are diagrams illustrating an example of a hardware configuration of the gesture detection device according to the first embodiment.

### DESCRIPTION OF EMBODIMENTS

Hereinafter, embodiments of the present disclosure will be described in detail with reference to the drawings.

### First Embodiment

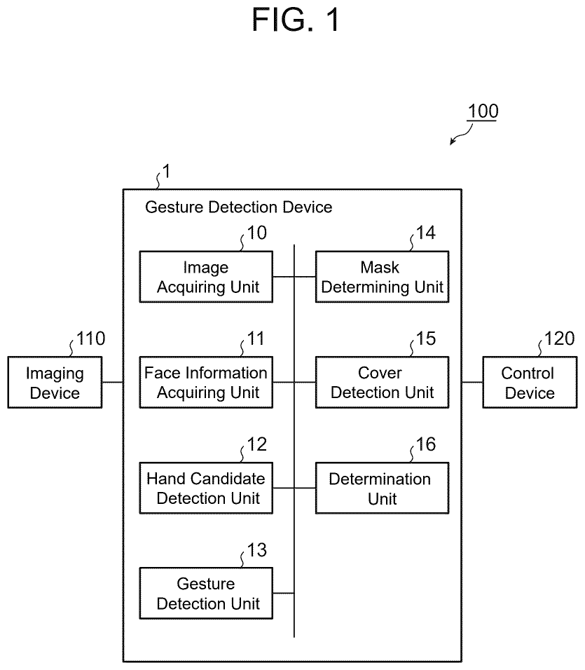

FIG. 1 is a diagram illustrating a configuration example of an occupant monitoring system 100 including a gesture detection device 1 according to a first embodiment. In the following description, a case where the gesture detection device 1 according to the first embodiment is mounted on the occupant monitoring system 100 will be described as an example.

For example, as illustrated in FIG. 1, the occupant monitoring system 100 includes an imaging device 110, the gesture detection device 1, and a control device 120.

The imaging device 110 includes, for example, a camera disposed in a vehicle (not illustrated), and captures the interior of the vehicle including occupants of the vehicle in time series. The imaging device 110 sequentially outputs images (hereinafter also referred to as a “captured image”) obtained by capturing to the gesture detection device 1.

The gesture detection device 1 detects (recognizes) a gesture by a person (here, an occupant of the vehicle) on the basis of the captured image output from the imaging device 110, and outputs information indicating the detected gesture to the control device 120.

The control device 120 executes predetermined control on the basis of the gesture indicated by the information output from the gesture detection device 1. For example, when the gesture indicated by the information output from the gesture detection device 1 is a gesture for operating an in-vehicle device such as an air conditioner and an audio system, the control device 120 executes temperature adjustment of the air conditioner, volume adjustment of the audio system, and the like on the basis of the gesture. Note that, the in-vehicle device is not limited to the air conditioner and the audio system.

### Gesture Detection Device 1

For example, as illustrated in FIG. 1, the gesture detection device 1 includes an image acquiring unit 10, a face information acquiring unit 11, a hand candidate detection unit 12, a gesture detection unit 13, a mask determination unit 14, a cover detection unit 15, and a determination unit 16.

The image acquiring unit 10 acquires a captured image output from the imaging device 110. The image acquiring unit 10 outputs the acquired captured image to the face information acquiring unit 11, the hand candidate detection unit 12, and the mask determination unit 14.

The face information acquiring unit 11 acquires information of the face (hereinafter also referred to as “face information”) of the occupant on the basis of the captured image output from the image acquiring unit 10. The face information acquiring unit 11 outputs the acquired face information to the cover detection unit 15.

Note that the face information of the occupant is, for example, information indicating an image obtained by cutting out an area in which the face of the occupant is photographed from the captured image output from the image acquiring unit 10. The face information of the occupant may include information indicating a part belonging to the face such as an eye, an eyebrow, a nose, a mouth, a forehead, a cheek, or a chin, information indicating a position of the part in the captured image, and the like.

The hand candidate detection unit 12 detects a hand candidate that is a candidate for the hand of the occupant on the basis of the captured image output from the image acquiring unit 10. Note that the detected hand candidate also includes a position and a shape of the hand candidate. The hand candidate detection unit 12 outputs information indicating the detected hand candidate to the gesture detection unit 13.

Note that the hand candidate detection unit 12 detects a hand candidate of the occupant by, for example, matching a pattern of a shape of an object (luminance distribution information) in the captured image output from the image acquiring unit 10 with a predetermined pattern of a shape of the hand, that is, by pattern matching processing. The shape of the hand to be detected may be either the shape of the hand in an open state or a shape of the hand in a closed state. In addition, the shape of the hand to be detected may be, for example, a shape of a hand indicating a number, a shape of a hand indicating a direction, a shape of a hand indicating an intention (such as OK or Good) of an occupant, or the like.

Further, the hand candidate detection unit 12 may detect a hand candidate using, for example, a machine learning model. In this case, the machine learning model only needs to be, for example, a trained model trained to output a result of inferring the hand candidate of the occupant with respect to an input of a captured image obtained by capturing the occupant.

The gesture detection unit 13 detects a gesture of the occupant on the basis of the position and the shape of the hand candidate indicated by the information output from the hand candidate detection unit 12. The gesture detection unit 13 outputs information indicating the detected gesture of the occupant to the determination unit 16.

Note that the gesture detection unit 13 detects a gesture of the occupant using, for example, a machine learning model. In this case, the machine learning model is, for example, a trained model trained to output a result of inferring a gesture corresponding to a hand candidate indicated by information in response to input of the information indicating the hand candidate of the occupant.

The mask determination unit 14 determines whether or not the occupant is wearing a mask on the basis of the captured image output from the image acquiring unit 10. The mask determination unit 14 outputs information indicating a determination result to the cover detection unit 15 and the determination unit 16.

Note that the mask determination unit 14 determines whether or not the occupant is wearing a mask using, for example, a machine learning model. In this case, the machine learning model is, for example, a trained model trained to output a result of inferring whether or not the occupant is wearing a mask with respect to an input of a captured image obtained by capturing the occupant.

Note that the mask determination unit 14 may determine whether or not the occupant is wearing a mask on the basis of the face information of the occupant acquired by the face information acquiring unit 11. In this case, the mask determination unit 14 only needs to use, as the trained model, for example, a trained model trained to output a result of inferring whether or not the occupant is wearing a mask in response to the input of the face information of the occupant.

When the information output from the mask determination unit 14 indicates that the occupant is not wearing a mask, the cover detection unit 15 determines whether or not the mouth of the occupant is covered on the basis of the face information of the occupant output from the face information acquiring unit 11. The cover detection unit 15 outputs information indicating the determination result to the determination unit 16. Note that the cover detection unit 15 only needs to perform the above determination only when the information output from the mask determination unit 14 indicates that the occupant is not wearing a mask, and does not need to perform the above determination when the information output from the mask determination unit 14 indicates that the occupant is wearing a mask.

The cover detection unit 15 determines whether or not the mouth of the occupant is covered using, for example, a machine learning model. In this case, the machine learning model is, for example, a trained model trained to output a result of inferring whether or not the mouth of the occupant is covered in response to the input of the face information of the occupant.

Note that, in the above description, it has been described that the cover detection unit 15 determines whether or not the mouth of the occupant is covered on the basis of the face information of the occupant output from the face information acquiring unit 11. However, the cover detection unit 15 is not limited thereto, and may determine whether or not a part or all of the face of the occupant is covered on the basis of, for example, the face information of the occupant output from the face information acquiring unit 11. Furthermore, in this case, the cover detection unit 15 only needs to be able to determine whether or not at least the mouth of the occupant is covered on the basis of, for example, the face information of the occupant output from the face information acquiring unit 11.

When the information output from the mask determination unit 14 indicates that the occupant is wearing a mask, the determination unit 16 recognizes the gesture indicated by the information output from the gesture detection unit 13 as the gesture of the occupant.

Further, when the information output from the mask determination unit 14 indicates that the occupant is not wearing a mask and the information output from the cover detection unit 15 indicates that the mouth of the occupant is not covered, the determination unit 16 recognizes the gesture indicated by the information output from the gesture detection unit 13 as the gesture of the occupant.

On the other hand, when the information output from the mask determination unit 14 indicates that the occupant is not wearing a mask and the information output from the cover detection unit 15 indicates that the mouth of the occupant is covered, the determination unit 16 rejects the gesture indicated by the information output from the gesture detection unit 13 without recognizing the gesture as the gesture of the occupant.

Note that, when the information output from the mask determination unit 14 indicates that the occupant is not wearing a mask, the determination unit 16 may calculate a distance between the hand candidate and the mouth of the occupant on the basis of the information indicating the hand candidate detected by the hand candidate detection unit 12 and the face information of the occupant acquired by the face information acquiring unit 11 before determining rejection or recognition of the gesture based on the information output from the cover detection unit 15.

For example, when the information output from the mask determination unit 14 indicates that the occupant is not wearing a mask, the determination unit 16 acquires a detection box of a hand candidate on the basis of the information indicating the hand candidate detected by the hand candidate detection unit 12, and acquires a detection box of the mouth of the occupant on the basis of the face information of the occupant acquired by the face information acquiring unit 11. Note that the determination unit 16 can acquire the detection box of the hand candidate of the occupant and the detection box of the mouth of the occupant using a known method. Then, the determination unit 16 calculates the minimum distance between the acquired detection box of the hand candidate of the occupant and detection box of the mouth of the occupant as the distance between the hand candidate and the mouth of the occupant.

Then, when the calculated distance exceeds a predetermined threshold, the determination unit 16 may recognize the gesture detected by the gesture detection unit 13 as the gesture of the occupant regardless of the information output from the cover detection unit 15. Furthermore, the determination unit 16 may determine rejection or recognition of the gesture based on the information output from the cover detection unit 15 only when the calculated distance is equal to or less than a predetermined threshold value. In this manner, the determination unit 16 performs the determination based on the distance between the hand candidate and the mouth of the occupant prior to the determination of rejection or recognition of the gesture based on the information output from the cover detection unit 15, thereby increasing the opportunity to determine whether to reject or recognize the gesture, and improving the determination accuracy regarding the rejection or the recognition of the gesture.

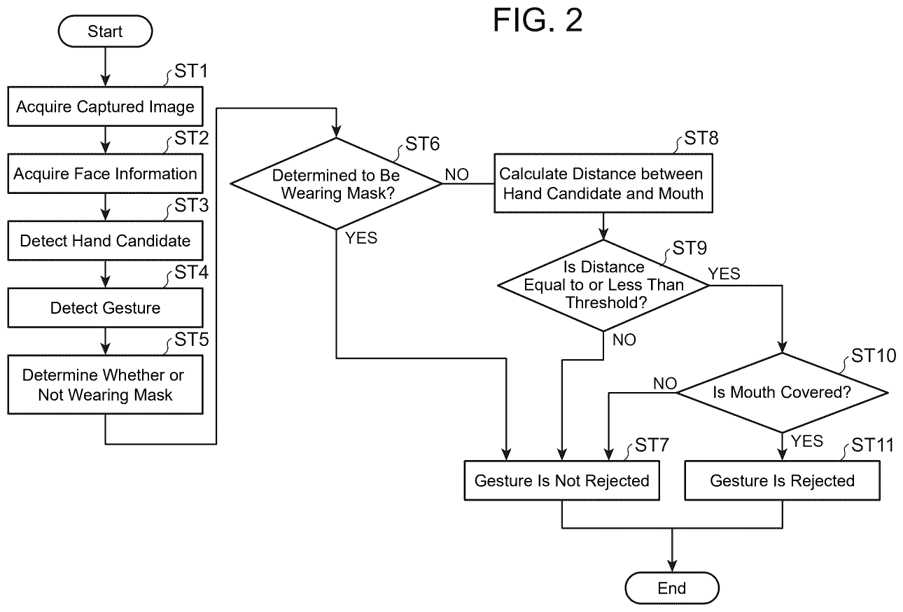

Next, a motion example of the gesture detection device 1 according to the first embodiment will be described with reference to the flowchart illustrated in FIG. 2. Note that, in the following description, a case will be described as an example in which the determination unit 16 makes a determination based on the distance between the hand candidate and the mouth of the occupant prior to the determination of rejection or recognition of the gesture based on the information output from the cover detection unit 15.

The image acquiring unit 10 acquires a captured image from the imaging device 110 (step ST1). The image acquiring unit 10 outputs the acquired captured image to the face information acquiring unit 11, the hand candidate detection unit 12, and the mask determination unit 14.

Next, the face information acquiring unit 11 acquires information of the face (face information) of the occupant on the basis of the captured image output from the image acquiring unit 10 (step ST2). The face information acquiring unit 11 outputs the acquired face information to the cover detection unit 15 and the determination unit 16.

Next, the hand candidate detection unit 12 detects a hand candidate that is a candidate of the hand of the occupant on the basis of the captured image output from the image acquiring unit 10 (step ST3). The hand candidate detection unit 12 outputs information indicating the detected hand candidate to the gesture detection unit 13 and the determination unit 16.

Next, the gesture detection unit 13 detects a gesture of the occupant on the basis of the position and shape of the hand candidate indicated by the information output from the hand candidate detection unit 12 (step ST4). The gesture detection unit 13 outputs information indicating the detected gesture of the occupant to the determination unit 16.

Next, the mask determination unit 14 determines whether or not the occupant is wearing a mask on the basis of the captured image output from the image acquiring unit 10 (step ST5). The mask determination unit 14 outputs information indicating a determination result to the cover detection unit 15 and the determination unit 16.

Next, the determination unit 16 checks whether or not the information output from the mask determination unit 14 indicates that the occupant is wearing a mask, that is, whether or not it is determined by the mask determination unit 14 that the occupant is wearing a mask (step ST6). As a result, when it is confirmed that it is determined by the mask determination unit 14 that the occupant is wearing a mask (step ST6; YES), the determination unit 16 does not reject the gesture detected by the gesture detection unit 13 in step ST4, and recognizes the gesture as the gesture of the occupant (step ST7).

On the other hand, when the determination unit 16 has confirmed that the mask determination unit 14 has determined that the occupant is not wearing a mask (step ST6; NO), the determination unit 16 calculates the distance between the hand candidate and the mouth of the occupant on the basis of the information indicating the hand candidate detected by the hand candidate detection unit 12 and the face information of the occupant acquired by the face information acquiring unit 11 (step ST8).

Then, the determination unit 16 checks whether or not the calculated distance is equal to or less than a predetermined threshold value (step ST9). As a result, when the calculated distance is not equal to or less than the threshold (step ST9; NO), the process proceeds to step ST7, and the determination unit 16 does not reject the gesture detected by the gesture detection unit 13 in step ST4 and recognizes the gesture as the gesture of the occupant. On the other hand, when the calculated distance is equal to or less than the threshold (step ST9; YES), the process proceeds to step ST10.

In step ST10, the cover detection unit 15 determines whether or not the mouth of the occupant is covered on the basis of the face information of the occupant output from the face information acquiring unit 11, and outputs information indicating a determination result to the determination unit 16. Then, the determination unit 16 determines whether or not the information output from the cover detection unit 15 indicates that the mouth of the occupant is covered (step ST10).

As a result, when it is confirmed that the information output from the cover detection unit 15 indicates that the mouth of the occupant is covered (step ST10; YES), the determination unit 16 rejects the gesture indicated by the information output from the gesture detection unit 13 in step ST4 without recognizing the gesture as the gesture of the occupant (step ST11).

On the other hand, when the determination unit 16 has confirmed that the information output from the cover detection unit 15 indicates that the mouth of the occupant is not covered (step ST10; NO), the determination unit 16 does not reject the gesture detected by the gesture detection unit 13 in step ST4, and recognizes the detected gesture as the gesture of the occupant (step ST7).

Note that, in the above description, the case where the determination unit 16 calculates the distance between the hand candidate and the mouth of the occupant in steps ST8 to ST9 before determining rejection or recognition of the gesture based on the information output from the cover detection unit 15 in step ST10, and performs the determination based on the calculated distance has been described. However, the processing of steps ST8 to ST9 is not essential and may be omitted. In this case, if it is confirmed in step ST6 that the occupant is not wearing a mask, the process only needs to proceed to step ST10. Note that, by performing the processing of steps ST8 to ST9, the determination unit 16 can increase the opportunity to determine whether to reject or recognize the gesture, and the determination accuracy regarding the rejection or recognition of the gesture is improved.

As described above, in the gesture detection device 1 according to the first embodiment, when the mask determination unit 14 has determined that the occupant is not wearing a mask, the cover detection unit 15 determines whether or not the mouth of the occupant is covered. Then, in the gesture detection device 1, when the cover detection unit 15 has determined that the mouth of the occupant is covered, the determination unit 16 rejects the gesture detected by the gesture detection unit 13. Thus, the gesture detection device 1 can suppress erroneous detection of a motion performed by the occupant when eating or drinking as a gesture.

Note that, in the above description, an example has been described in which the detection target of the gesture by the gesture detection device 1 is the occupant of the vehicle, but the detection target of the gesture is not limited to the occupant of the vehicle, and only needs to be any person that can be imaged by the imaging device.

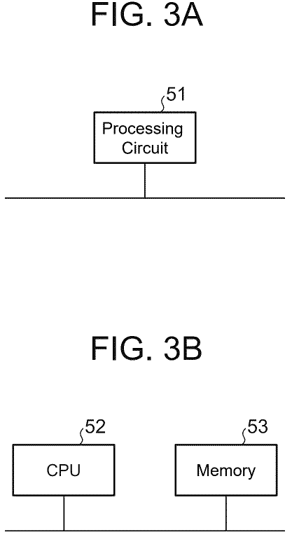

Next, a hardware configuration example of the gesture detection device 1 according to the first embodiment will be described with reference to FIG. 3. The functions of the image acquiring unit 10, the face information acquiring unit 11, the hand candidate detection unit 12, the gesture detection unit 13, the mask determination unit 14, the cover detection unit 15, and the determination unit 16 in the gesture detection device 1 are implemented by a processing circuit. The processing circuit may be dedicated hardware as illustrated in FIG. 3A, or may be a central processing unit (CPU, which may also be referred to as a central processing device, a processing device, an arithmetic device, a microprocessor, a microcomputer, a processor, or a digital signal processor (DSP)) 52 that executes a program stored in a memory 53 as illustrated in FIG. 3B.

In a case where the processing circuit is dedicated hardware, the processing circuit 51 corresponds to, for example, a single circuit, a composite circuit, a programmed processor, a parallel programmed processor, an application specific integrated circuit (ASIC), a field programmable gate array (FPGA), or a combination thereof. Each function of the image acquiring unit 10, the face information acquiring unit 11, the hand candidate detection unit 12, the gesture detection unit 13, the mask determination unit 14, the cover detection unit 15, and the determination unit 16 may be implemented by the processing circuit 51, or the function of each unit may be collectively implemented by the processing circuit 51.

In a case where the processing circuit is the CPU 52, the functions of the image acquiring unit 10, the face information acquiring unit 11, the hand candidate detection unit 12, the gesture detection unit 13, the mask determination unit 14, the cover detection unit 15, and the determination unit 16 are implemented by software, firmware, or a combination of software and firmware. The software and the firmware are described as programs and stored in the memory 53. The processing circuit implements the function of each unit by reading and executing the programs recorded in the memory 53. That is, the gesture detection device 1 includes a memory for storing a program that results in execution of each step illustrated in FIG. 2, for example, when executed by the processing circuit. Further, it can also be said that these programs cause a computer to execute the procedures and methods performed by the image acquiring unit 10, the face information acquiring unit 11, the hand candidate detection unit 12, the gesture detection unit 13, the mask determination unit 14, the cover detection unit 15, and the determination unit 16. Here, the memory 53 corresponds to, for example, a nonvolatile or volatile semiconductor memory such as a random access memory (RAM), a read only memory (ROM), a flash memory, an erasable programmable ROM (EPROM), or an electrically-EPROM (EEPROM), a magnetic disk, a flexible disk, an optical disk, a compact disk, a mini disk, or a digital versatile disc (DVD).

Note that the functions of the image acquiring unit 10, the face information acquiring unit 11, the hand candidate detection unit 12, the gesture detection unit 13, the mask determination unit 14, the cover detection unit 15, and the determination unit 16 may be partially implemented by dedicated hardware and partially implemented by software or firmware. For example, the functions of the image acquiring unit 10 can be implemented by a processing circuit as dedicated hardware, and the functions of the face information acquiring unit 11, the hand candidate detection unit 12, the gesture detection unit 13, the mask determination unit 14, the cover detection unit 15, and the determination unit 16 can be implemented by the processing circuit reading and executing programs stored in the memory 53.

As described above, the processing circuit can implement the functions by hardware, software, firmware, or a combination thereof.

As described above, according to the first embodiment, the gesture detection device 1 includes the hand candidate detection unit 12 to detect a hand candidate that is a candidate of a hand of a person on the basis of a captured image obtained by capturing the person, the gesture detection unit 13 to detect a gesture of the person on the basis of the hand candidate detected by the hand candidate detection unit 12, the mask determination unit 14 to determine whether or not the person is wearing a mask on the basis of the captured image, the cover detection unit 15 to determine whether or not a mouth of the person is covered on the basis of face information of the person obtained on the basis of the captured image when the mask determination unit 14 has determined that the person is not wearing a mask, and the determination unit 16 to reject the gesture detected by the gesture detection unit 13 when the cover detection unit 15 has determined that the mouth of the person is covered. As a result, the gesture detection device 1 according to the first embodiment can suppress erroneous detection of a motion performed by a person when eating or drinking as a gesture.

Further, when the mask determination unit 14 has determined that the person is wearing a mask, the determination unit 16 recognizes the gesture detected by the gesture detection unit 13 as a gesture of the person. Thus, the gesture detection device 1 according to the first embodiment can detect a gesture performed by a person wearing a mask.

Furthermore, in a case where the mask determination unit 14 has determined that the person is not wearing a mask, and when the cover detection unit 15 has determined that the mouth of the person is not covered, the determination unit 16 recognizes the gesture detected by the gesture detection unit 13 as a gesture of the person. As a result, the gesture detection device 1 according to the first embodiment can detect, as a gesture, a motion other than the eating motion performed by the person when not wearing a mask.

Furthermore, the determination unit 16 calculates, when the mask determination unit 14 has determined that the person is not wearing a mask, a distance between the hand candidate and the mouth of the person on the basis of a position of the hand candidate detected by the hand candidate detection unit 12 and the face information of the person, and rejects, when the calculated distance is equal to or less than a threshold and the cover detection unit 15 has determined that the mouth of the person is covered, the gesture detected by the gesture detection unit 13, and recognizes, when the calculated distance exceeds the threshold or the cover detection unit 15 has determined that the mouth of the person is not covered even when the calculated distance is equal to or less than the threshold, the gesture detected by the gesture detection unit 13 as a gesture of the person. Thus, the gesture detection device 1 according to the first embodiment can increase the opportunity to determine whether to reject or recognize the gesture, and the determination accuracy is improved.

Further, the mask determination unit 14 determines whether or not the person is wearing a mask using a trained model that outputs whether or not the person is wearing a mask in response to an input of a captured image obtained by capturing the person. Thus, the gesture detection device 1 according to the first embodiment can accurately determine whether or not a person is wearing a mask, and determination accuracy regarding rejection or recognition of a gesture is improved.

In addition, the cover detection unit 15 determines whether or not the mouth of the person is covered using a trained model that outputs whether or not the mouth of the person is covered in response to an input of the face information of the person. Thus, the gesture detection device 1 according to the first embodiment can accurately determine whether or not the mouth of the person is covered, and determination accuracy regarding rejection or recognition of the gesture is improved.

Furthermore, the gesture detection unit 13 detects a gesture of the person using a trained model that receives, as an input, information indicating a position and a shape of the hand candidate and outputs a gesture corresponding to the position and the shape of the hand candidate indicated by the information. Thus, the gesture detection device 1 according to the first embodiment can accurately detect the gesture of the person.

In addition, the occupant monitoring system 100 according to the first embodiment includes the gesture detection device 1, and includes the imaging device 110 to capture an occupant of a vehicle as a person, and the control device 120 to execute predetermined control on the basis of a gesture recognized by the determination unit 16. Thus, the occupant monitoring system 100 according to the first embodiment can suppress erroneous control caused by erroneous detection of a motion performed by an occupant of the vehicle when eating or drinking as a gesture.

Note that, in the present disclosure, any component of the embodiment can be modified, or any component in the embodiment can be omitted.

### Industrial Applicability

The present disclosure can suppress erroneous detection of a motion performed by a person when eating or drinking as a gesture, and is suitable for use in a gesture detection device, an occupant monitoring system, and a gesture detection method.

### REFERENCE SIGNS LIST

1: gesture detection device, 10: image acquiring unit, 11: face information acquiring unit, 12: hand candidate detection unit, 13: gesture detection unit, 14: mask determination unit, 15: cover detection unit, 16: determination unit, 51: processing circuit, 52: CPU, 53: memory, 100: occupant monitoring system, 110: imaging device, 120: control device

1. A gesture detection device comprising:
processing circuitry
to detect a hand candidate that is a candidate of a hand of a person on a basis of a captured image obtained by capturing the person;
to detect a gesture of the person on a basis of the detected hand candidate;
to determine whether or not the person is wearing a mask on a basis of the captured image;
to determine whether or not a mouth of the person is covered on a basis of face information of the person obtained on a basis of the captured image when the person is determined not to be wearing a mask; and
to reject the detected gesture when the mouth of the person is determined to be covered.

2. The gesture detection device according to claim 1, wherein
the processing circuitry, when the person is determined to be wearing a mask,
recognizes the detected gesture as a gesture of the person.

3. The gesture detection device according to claim 1, wherein
the processing circuitry, when the person is determined not to be wearing a mask, and when the mouth of the person is determined not to be covered,
recognizes the detected gesture as a gesture of the person.

4. The gesture detection device according to claim 3, wherein
the processing circuitry calculates,
when the person is determined not to be wearing a mask, a distance between the hand candidate and the mouth of the person on a basis of a position of the detected hand candidate and the face information of the person,
rejects, when the calculated distance is equal to or less than a threshold and the mouth of the person is determined to be covered, the detected gesture, and
recognizes, when the calculated distance exceeds the threshold or the mouth of the person is determined not to be covered even when the calculated distance is equal to or less than the threshold, the detected gesture detected as a gesture of the person.

5. The gesture detection device according to claim 1, wherein
the processing circuitry determines
whether or not the person is wearing a mask using a trained model that outputs whether or not the person is wearing a mask in response to an input of a captured image obtained by capturing the person.

6. The gesture detection device according to claim 1, wherein
the processing circuitry determines
whether or not the mouth of the person is covered using a trained model that outputs whether or not the mouth of the person is covered in response to an input of the face information of the person.

7. The gesture detection device according to claim 1, wherein
the processing circuitry detects
a gesture of the person using a trained model that receives, as an input, information indicating a position and a shape of the hand candidate and outputs a gesture corresponding to the position and the shape of the hand candidate indicated by the information.

8. An occupant monitoring system comprising the gesture detection device according to claim 1, the occupant monitoring system comprising:
an imaging device to capture an occupant of a vehicle as the person; and
a control device to execute predetermined control on a basis of the gesture recognized by the processing circuitry.

9. A gesture detection method comprising:
detecting a hand candidate that is a candidate of a hand of a person on a basis of a captured image obtained by capturing the person;
detecting a gesture of the person on a basis of the detected hand candidate;
determining whether or not the person is wearing a mask on a basis of the captured image;
determining whether or not a mouth of the person is covered on a basis of face information of the person obtained on a basis of the captured image when the person is determined not to be wearing a mask; and
rejecting the detected gesture when the mouth of the person is determined to be covered.

10. An occupant monitoring system comprising the gesture detection device according to claim 2, the occupant monitoring system comprising:
an imaging device to capture an occupant of a vehicle as the person; and
a control device to execute predetermined control on a basis of the gesture recognized by the processing circuitry.

11. An occupant monitoring system comprising the gesture detection device according to claim 3, the occupant monitoring system comprising:
an imaging device to capture an occupant of a vehicle as the person; and
a control device to execute predetermined control on a basis of the gesture recognized by the processing circuitry.

12. An occupant monitoring system comprising the gesture detection device according to claim 4, the occupant monitoring system comprising:
an imaging device to capture an occupant of a vehicle as the person; and
a control device to execute predetermined control on a basis of the gesture recognized by the processing circuitry.

13. An occupant monitoring system comprising the gesture detection device according to claim 5, the occupant monitoring system comprising:
an imaging device to capture an occupant of a vehicle as the person; and
a control device to execute predetermined control on a basis of the gesture recognized by the processing circuitry.

14. An occupant monitoring system comprising the gesture detection device according to claim 6, the occupant monitoring system comprising:
an imaging device to capture an occupant of a vehicle as the person; and
a control device to execute predetermined control on a basis of the gesture recognized by the processing circuitry.

15. An occupant monitoring system comprising the gesture detection device according to claim 7, the occupant monitoring system comprising:
an imaging device to capture an occupant of a vehicle as the person; and
a control device to execute predetermined control on a basis of the gesture recognized by the processing circuitry.
